(19) United States
(12) Patent Application Publication
(10) Pub. No.: US 2003/0086015 A1
(43) Pub. Date: May 8, 2003

(54) System and method for combining video stream with digital information

(76) Inventors: Eero Korhonen, Helsinki (FI); Marcus Wiklund, Helsinki (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/274,377

(22) Filed: Oct. 21, 2002

(30) Foreign Application Priority Data
Oct. 19, 2001 (FI) 20012041

(51) Int. Cl. H04N 7/173; H04N 7/16; H04N 7/12; H04N 11/02; H04N 11/04; H04J 3/02

(52) U.S. Cl. 348/423.1; 725/112; 725/136; 370/537

(57) ABSTRACT

The present invention relates in general to producing of digital information and digital broadcasting and more specifically to system and method for combining video stream with digital information. The presented solution for combining video stream with digital information can be utilized in different future networks, such as digital television networks, third generation mobile networks and IP networks (IP, Internet Protocol).

### TECHNICAL FIELD OF THE INVENTION

The present invention relates in general to producing of digital information and digital broadcasting and more specifically to system and method for combining video stream with digital information.

### BACKGROUND OF THE INVENTION

The producing of digital information and digital broadcasting have developed rapidly in the recent years. For example, today's videos or DVDs (DVD, Digital Versatile Disc) provide the user with a lot of different options to select how to view the content.

For a better understanding of the prior art relation to the present invention reference will be made to the accompanying FIG. 1, which illustrates a prior art digital broadcasting system.

FIG. 1 illustrates a prior art digital broadcasting system. The presented prior art digital broadcasting system has several audio and video sources e.g. video cameras and other video sources. The prior art digital broadcasting system has a Video Processing unit 1, a Broadcast unit 2, a multiplexer 6, and a transmitter unit 9. The Broadcast unit 2 has a Play Out unit 3 a broadcast automation system 4 and a Data Carousel unit 5.

Video cameras have first recorded the event to a recorded video signal. The recorded video signal is next forwarded to a Video Processing unit 1, which is used to combine the different recorded video signals to a single video program stream. In the Video Processing unit 1, there is typically made adjustments, editing and modifications (Video Processing) to the recorded video signals.

The processed single video program stream is next forwarded to a Play Out unit 3. A Play Out unit 3 normally handles the processing of several video program streams. These program streams are then forwarded to a multiplexer 6, which is used to multiplex different video program streams into a multi-program transport stream.

It is nowadays possible to combine data to the video program stream. This data is typically presented in the form of teletext pages, for example airport schedule information. The application data is usually stored in a Digital Storage Medium. The Digital Storage Medium can for example be a Data Carousel 5, from which the said application data is forwarded to the multiplexer 6. The multiplexer 6 is used to multiplex different digital video program streams and digital data streams into a multi-program transport stream.

Data Carousel 5 is basically a memory database, where data sets from the different application sources 7 are assembled into a buffer. From the buffer the data sets are played out in a cyclic manner. There is also a system information table 8 linked to the multiplexer 6.

From the multiplexer 6 the broadcasting stream is forwarded to a transmitter unit 9. The transmitter unit 9 sends the stream over a transport network 10 to the receiving unit 11. The receiving unit 11 presents the information in a monitoring unit 12 e.g. a television. The monitoring unit 12 and/or the receiving unit 11 can be controlled by a controlling unit 13.

### SUMMARY OF THE PRESENT INVENTION

It is an object of the present invention to overcome or at least mitigate the disadvantages of the prior art. The present invention provides a system and a method for transmitting and receiving digital information, a digital information combining means, a digital information presenting means, a method for combining video stream with digital information, a method for presenting digital information combined with a video stream and a method for performing a business transaction in a digital transmission system.

According to a first aspect of the present invention there is provided a system for transmitting and receiving digital information, said system comprising:

processing means for combining recorded signals from different audio and video sources to a single video program stream,

motion tracking means for defining active areas in a selected video program stream,

linking means for linking appropriate application data to the corresponding active areas in the video program stream,

transmitting means for transmitting the video stream over a transport network to the receiving side,

receiving means for receiving the incoming video stream,

monitoring means for presenting the monitored program to the user, and

controlling means for controlling the receiving means and the monitoring means.

Preferably, in the system for transmitting and receiving digital information the said transmitting means comprises storing and forwarding means, and multiplexing means for multiplexing different digital video program streams and digital data streams into a multi-program transport stream, and sending means, so that the storing and forwarding means receives application data from different applications, and forwards the appropriate application data to the multiplexing means.

Preferably, in the system for transmitting and receiving digital information the said motion tracking means forwards the knowledge of the active areas to the said multiplexing means via the storing and forwarding means. Alternatively, the said motion tracking means forwards the knowledge of the active areas to the said multiplexing means via a system information table. Alternatively, the said motion tracking means forwards the knowledge of the active areas directly to the said multiplexing means.

Preferably, in the system for transmitting and receiving digital information the said storing and forwarding means has a Carousel unit and a Database server having a connection to one or more client units, so that the Database server receives information from the client units, stores the client information, and forwards the client information to the Carousel unit, and that the Carousel unit forwards the appropriate application data corresponding to the active areas to the multiplexing means. More preferably, the said storing and forwarding means has also an automation system, which controls both the Database server and the Carousel unit.

According to a second aspect of the present invention there is provided a data combining arrangement for combining application data to a video program stream in a digital transmission system, said data combining arrangement comprising:

processing means for combining recorded signals from different audio and video sources to a single video program stream,

motion tracking means for defining active areas in a selected video program stream, and

linking means for linking appropriate application data to the corresponding active areas in the video program stream, and

transmitting means for transmitting the video stream over a transport network to the receiving side.

Preferably, in the data combining arrangement the said transmitting means comprises storing and forwarding means, and multiplexing means for multiplexing different digital video program streams and digital data streams into a multi-program transport stream, and sending means, so that the storing and forwarding means receives application data from different applications, and forwards the appropriate application data to the multiplexing means.

Preferably, in the data combining arrangement the said motion tracking means forwards the knowledge of the active areas to the said multiplexing means via the storing and forwarding means. Alternatively, the said motion tracking means forwards the knowledge of the active areas to the said multiplexing means via a system information table. Alternatively, the said motion tracking means forwards the knowledge of the active areas directly to the said multiplexing means.

Preferably, in the data combining arrangement the said storing and forwarding means has a Carousel unit and a Database server having a connection to one or more client units, so that the Database server receives information from the client units, stores the client information, and forwards the client information to the Carousel unit, and that the Carousel unit forwards the appropriate application data corresponding to the active areas to the multiplexing means.

Preferably, the said storing and forwarding means has also an automation system, which controls both the Database server and the Carousel unit. Preferably, the active areas in a selected video program stream are defined by

selecting locking points,

defining the active areas around the locking points, and

tracking the movement of the locking points and the active areas in a selected video program stream using motion tracking means.

More preferably, the movement of the locking points is calculated based on differences between frames following each other. Preferably, the locking points are defined with vectors. Alternatively, the locking points are defined with coordinates.

Preferably, the active area corresponding to a specific locking point is defined as a function or a group of functions relating to the locking point. Preferably, the active area is updated for every frame. Alternatively, the active area remains same for X frames and is updated for every X^{th} frame, where X is an integer. Preferably, the size and the shape of the active areas depend on the distance between locking points located close to each other.

Alternatively, the size and the shape of the active areas depend on the distance between active areas located close to each other.

According to a third aspect of the present invention there is provided a data presenting arrangement for presenting a video program stream combined with application data in a digital transmission system, said data presenting arrangement comprising:

receiving means for receiving the incoming video stream from a digital broadcasting system, in which the application data is linked to the relating video program stream, and all the different video program streams are multiplexed into a multi-program transport stream,

monitoring means for presenting the monitored program to the user, and

controlling means for controlling the receiving means and the monitoring means.

Preferably, the receiving unit and the monitoring unit are combined as one unit. Alternatively, the receiving unit, the monitoring unit and the user control device are combined as one unit.

Preferably, the said data presenting arrangement also comprises transmitting means for transmitting information from the user to a service provider over a transport network. More preferably, the said controlling means is also used for controlling the transmitting unit.

Preferably, the transmitting unit is equipped for sending a business transaction request from the user to a service provider. Preferably, the transmitting unit is equipped for receiving a confirmation from the service provider to the user.

Preferably, the receiving unit, the monitoring unit and the transmitting unit are combined as one unit. Alternatively, the receiving unit, the monitoring unit, the user control device and the transmitting unit are combined as one unit.

Preferably, the said monitoring device has a screen display with a movable cursor, and means for cursor location detection. More preferably, the incoming multi-program stream also includes an application, which is used to produce a movable cursor for the monitoring device. Preferably, the said movable cursor can be controlled with the user control device.

Preferably, the incoming multi-program stream also includes an application, which is used for constantly tracking the movements of the selected locking points in a digital video program, and constantly comparing the location of the active areas relating to the locking points with the movements of the cursor. More preferably, the said screen display has a set of selecting buttons, which selecting buttons can be controlled with the user control device.

Preferably, when the cursor is moved to be on a defined active area, the first data application will start automatically. Preferably, the data application first shows a confirmation prompt to the user and asks the user to confirm with the user control device, that the user is willing to proceed with the data application.

Preferably, the data application shows information relating to the selected active area. More preferably, the data application displays selection buttons to the user. More preferably, the data application shows a selection button confirming a purchase of a product.

According to a fourth aspect of the present invention there is provided a method for transmitting and receiving a combined video stream with data, said method comprising the steps of:

defining data for active areas on a video stream,

sending data and video program over a transport network to the receiving side,

receiving data and video program at the receiving side, and

presenting data and video program stream to the user.

According to a fifth aspect of the present invention there is provided a method for combining video stream with data, said method comprising the steps of:

selecting locking points in a single picture of a incoming digital video program in a video stream,

defining active areas for the selected locking points, and

defining data and applications for the active areas.

According to a sixth aspect of the present invention there is provided a method for presenting a combined video stream with data, said method comprising the steps of:

announcing to the user that there is a data service present,

detecting the location of the cursor, and comparing the location of the cursor to the location of the active areas detected by an application received in the multi-program transport stream, and

when it is detected that the cursor is on the active areas, presenting the retrieved data from the data application.

Preferably, when it is detected that the cursor is on the active areas,

it is announced to the user that there is data service present,

user approval is detected, and

the retrieved data from the data application is presented.

According to a seventh aspect of the present invention there is provided a method for performing a business transaction in a digital transmission system, said method comprising the steps of:

announcing to the user that there is a data service present,

detecting the location of the cursor,

when it is detected that the cursor is on the active areas, presenting the retrieved data from the data application, and

the user performing a business transaction.

### BRIEF DESCRIPTION OF THE DRAWINGS

For a better understanding of the present invention and in order to show how the same may be carried into effect reference will now be made to the accompanying drawings, in which:

FIG. 1 illustrates a prior art digital broadcasting system.

FIG. 2 illustrates a digital broadcasting system according to the present invention.

FIG. 3 illustrates a Digital Storage Medium of the digital broadcasting system according to the present invention.

FIG. 4 illustrates the structure of operating multiple active applications in a digital broadcasting system according to the present invention.

FIG. 5 illustrates the selecting of locking points in a digital video program according to the present invention.

FIG. 6 illustrates the defining of active areas for the selected locking points in a digital video program according to the present invention.

FIG. 7 illustrates the selecting of locking points and the defining of active areas with the help of vectors in a digital video program according to the present invention.

FIG. 8 illustrates the defining of active areas and the cursor movement with the help of vectors in a digital video program according to the present invention.

FIG. 9 illustrates the selecting of locking points and the defining of active areas with the help of coordinates in a digital video program according to the present invention.

FIG. 10 illustrates the defining of active areas and the cursor movement with the help of coordinates in a digital video program according to the present invention.

FIG. 11 illustrates a receiving system for receiving a video stream combined with data according to the present invention.

FIG. 12 illustrates another embodiment of a receiving system for receiving a video stream combined with data according to the present invention.

FIG. 13 illustrates a monitoring unit according to the present invention.

FIG. 14 illustrates the starting of a data application in a receiving system according to the present invention.

FIG. 15 illustrates the activating of further options of a data application in a receiving system according to the present invention.

FIG. 16 illustrates a method for transmitting and receiving a combined video stream with data according to the present invention.

FIG. 17 illustrates a method for combining video stream with data according to the present invention.

FIG. 18 illustrates a method for presenting a combined video stream with data according to the present invention.

FIG. 19 illustrates a second alternative method for presenting a combined video stream with data according to the present invention.

FIG. 20 illustrates a third alternative method for presenting a combined video stream with data according to the present invention.

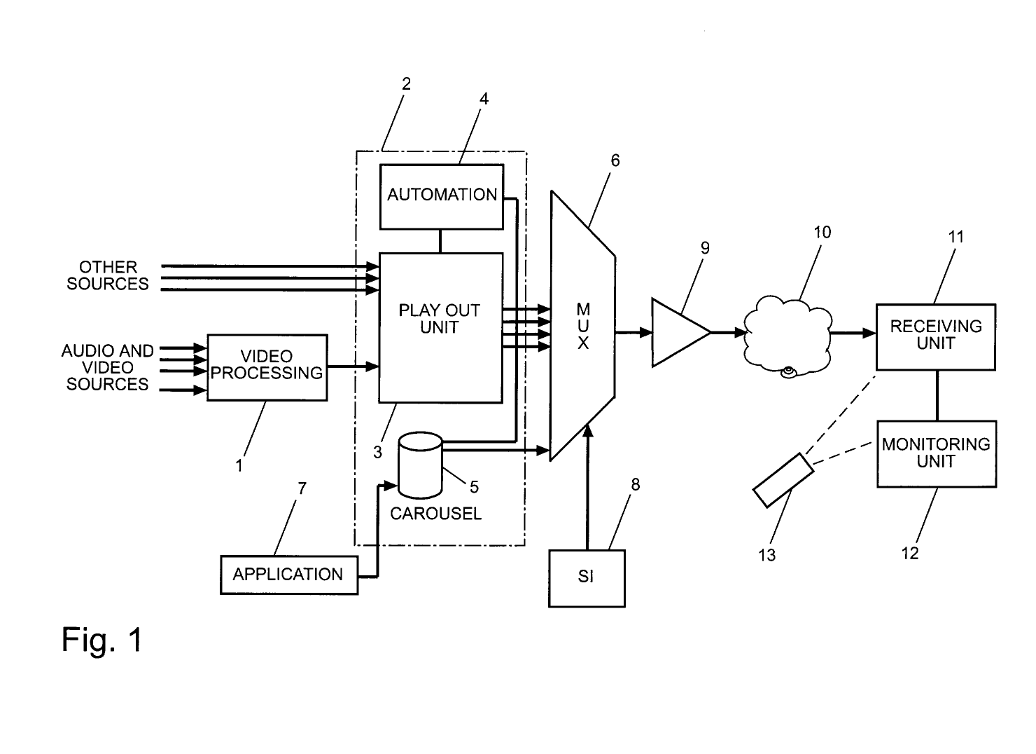

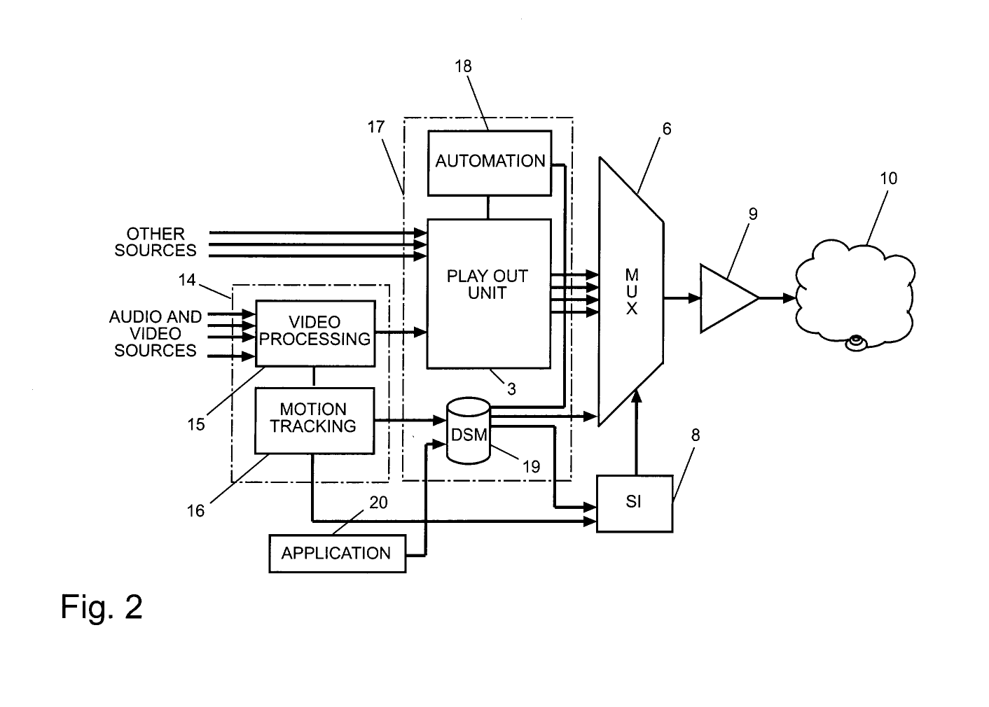

The FIG. 1 referring to the prior art has been discussed earlier. In the following, reference is made to the FIGS. 2-20.

### DETAILED DESCRIPTION OF CERTAIN EMBODIMENTS

FIG. 2 illustrates a digital broadcasting system according to the present invention. The presented digital broadcasting system has several audio and video sources e.g. video cameras and other video sources. The prior art digital broadcasting system has a Production unit 14, a Broadcast unit 2, a multiplexer 6, and a transmitter unit 9. The Production unit 14 has a Video Processing unit 15 and a Motion Tracking unit 16. The Broadcast unit 17 has a Play Out unit 3 a broadcast automation system 18 and a Data Carousel unit 19.

Video cameras have first recorded the event to a recorded video signal. The recorded video signal is next forwarded to a Video Processing unit 15, which is used to combine the different recorded video signals to a single video program stream.

The processed single video program stream is next forwarded to a Play Out unit 3. A Play Out unit 3 normally handles the processing of several video program streams. These program streams are then forwarded to a multiplexer 6, which is used to multiplex different digital video program streams and digital data streams into a multi-program transport stream.

In the digital broadcasting system according to the present invention the Video Processing unit 15 also forwards selected video program streams to a Motion Tracking unit 16. The Motion Tracking unit 16 is a unit tracking movements between video frames following each other, utilizing standard motion tracking techniques.

In the Motion Tracking unit 16 there are active areas defined in a selected video program stream. The knowledge of these active areas is then forwarded to the multiplexer 6. There is also a system information table 8 linked to the multiplexer 6.

In the digital broadcasting system according to the present invention there also is a Digital Storage Medium (DSM) e.g. a Data Carousel Unit 19. The Data Carousel Unit 19 also receives application data from different applications 20. The application data is then forwarded to the multiplexer 6. The multiplexer 6 is used to multiplex different digital video program streams and digital data streams into a multi-program transport stream.

The Motion Tracking unit 16 can also forward the knowledge of the active areas to a Digital Storage Medium (DSM) e.g. a Data Carousel Unit 19. In the Data Carousel Unit 19 there is also application data is received from different applications 20. The knowledge of the active areas and the appropriate application data is forwarded to the multiplexer 6. The multiplexer 6 is used to multiplex different digital video program streams and digital data streams into a multi-program transport stream.

The Motion Tracking unit 16 can also forward the knowledge of the active areas to the multiplexer 6 via the system information table 8. From the multiplexer 6 the broadcasting stream is forwarded to a transmitter unit 9. The transmitter unit 9 sends the stream over a transport network 10 to the receiving side.

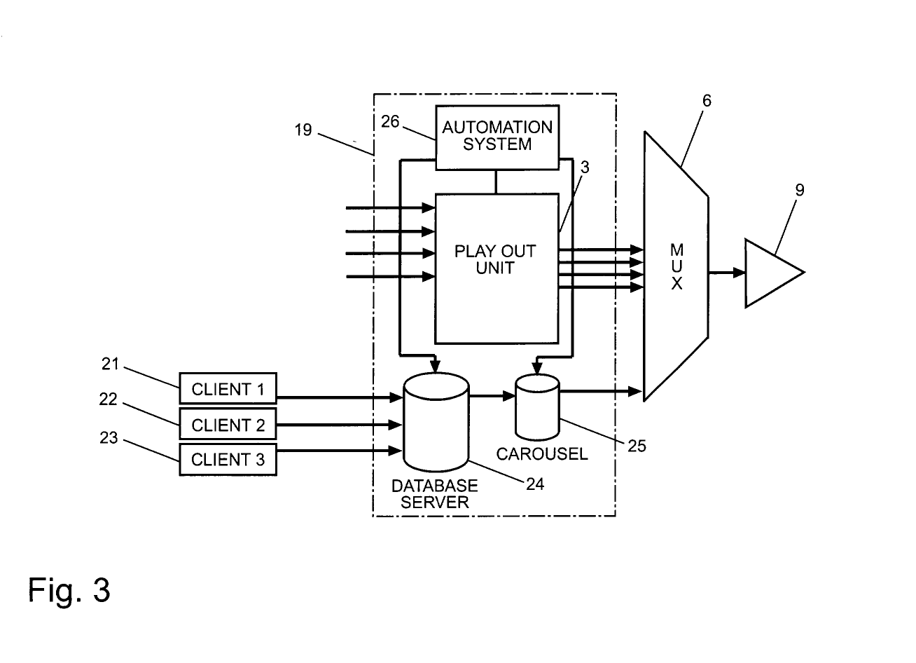

FIG. 3 illustrates a Digital Storage Medium of the digital broadcasting system according to the present invention. In the figure the video program streams are received from the Play Out unit 3 by a multiplexer 6, which is used to multiplex different video program streams and digital data streams into a multi-program transport stream forwarded to a transmitter unit 9.

In the digital broadcasting system according to the present invention the Digital Storage Medium is indicated with number 19. The Digital Storage Medium 19 has one or more client units 21-23 that give client information to a Database server 24 of the Digital Storage Medium 19.

The Database server 24 stores the information received from the client units 21-23 and forwards it to a Carousel unit 25. The Carousel unit 25 forwards the appropriate application data corresponding to the active areas to the multiplexer 6. The Digital Storage Medium 19 has also a control system 26, which controls both the Database server 24 and the Carousel unit 25. The multiplexer 6 is used to multiplex different digital video program streams and digital data streams into a multi-program transport stream.

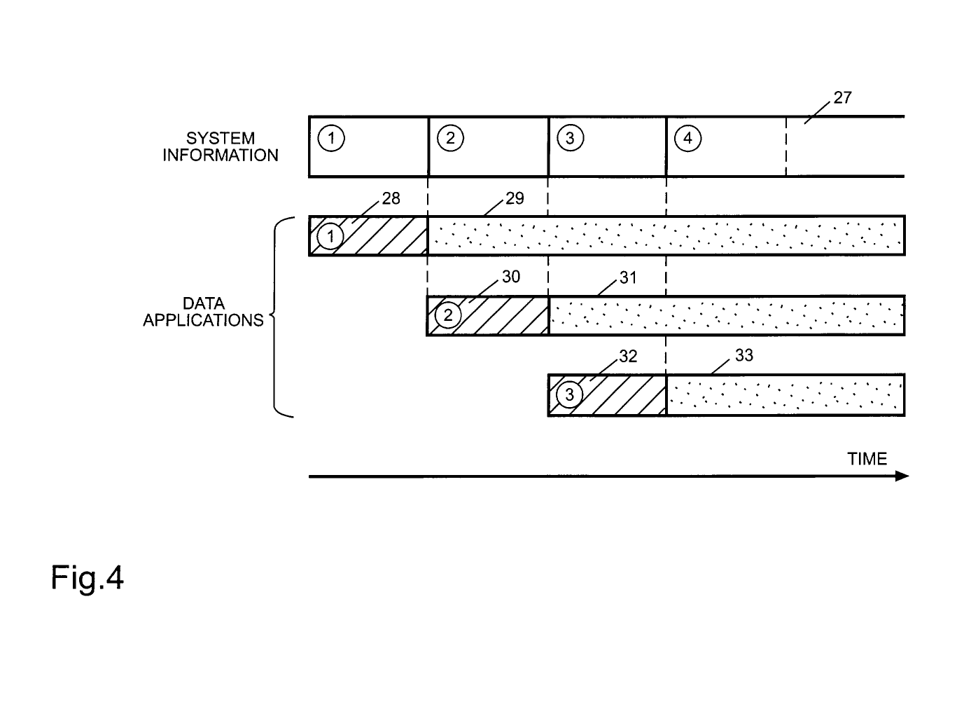

FIG. 4 illustrates the structure of operating multiple active applications in a digital broadcasting system according to the present invention. The applications and active areas can appear both sequently and simultaneously. In the present invention in the video program streams there has been defined active areas with linked data applications 29, 31, 33. Each of these data applications 29, 31, 33 have a specified activation time intervals, during which the said data applications 29, 31, 33 can be activated from the active areas during the program flow. These activation time intervals have been identified with numbers \mathring{1}, \mathring{2}, \mathring{3}, \mathring{4} in the system information flow 27.

For example the data application 29 can only be activated from the active areas during activation time interval \mathring{1} of the program flow. Respectively the data applications 31 and 33 can only be activated during activation time intervals \mathring{2} and \mathring{3}. The data application 29 can thus be started on the time interval marked with number 28 but not after. Respectively the data applications 31 and 33 can be started on the time intervals marked with numbers 30 and 32 but not after. Anyhow the data applications 29, 31, 33 once activated will continue to run after the starting time intervals 28, 30, 32 have elapsed.

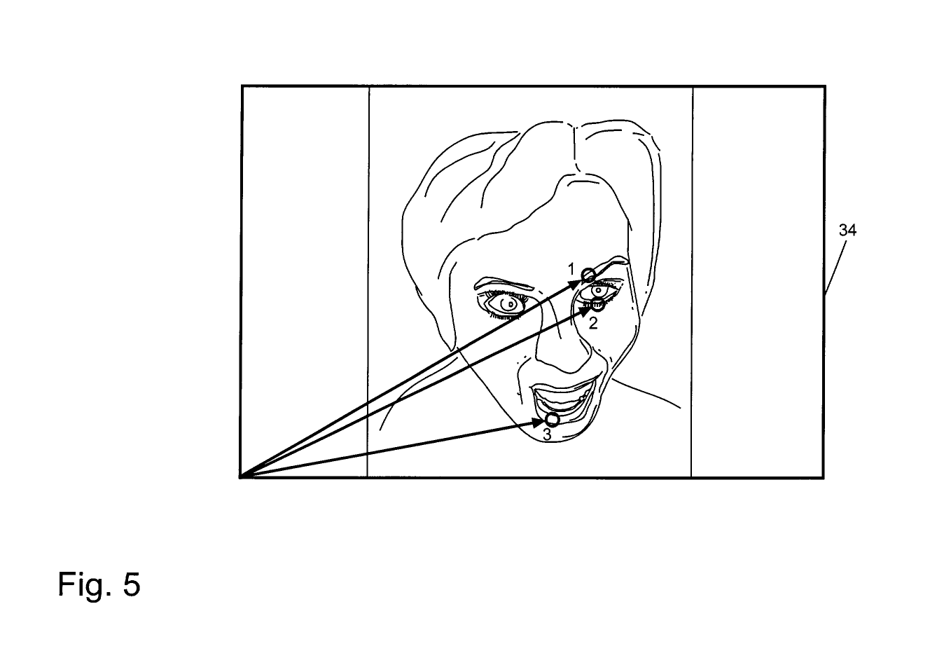

FIG. 5 illustrates the selecting of locking points in a digital video program according to the present invention.

In the digital broadcasting system according to the present invention there are selected locking points in a single picture 34 of a digital video program. In the picture 34 lady's eyebrow has one locking point, lady's lower eyelid has another locking point, and lady's lower lip has a third locking point. These locking points are followed with a standard motion tracking technique.

The selected locking points are each given a unique identifier. The first position of the locking point in the first picture is then defined e.g. with the help of length and angle of a vector. In a standard motion tracking technique a new-position of the locking point is calculated for each picture e.g. based on contrast differences in a group of pixels. This allows the tracking of the motion i.e. the movement of the locking point. In the digital broadcasting system according to the present invention the movements of the selected locking points in a digital video program are constantly tracked.

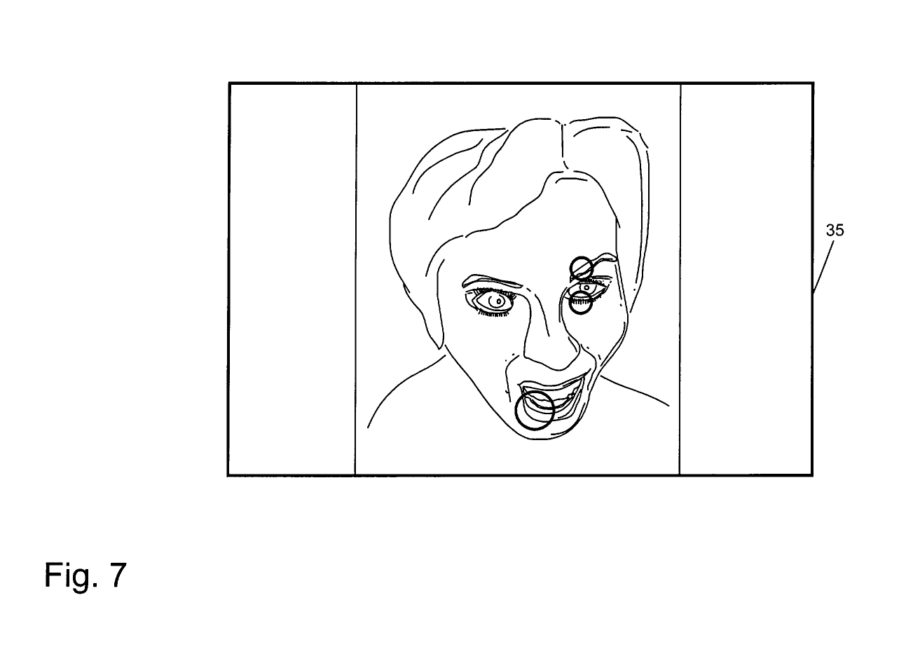

FIG. 6 illustrates the defining of active areas for the selected locking points in a digital video program according to the present invention. In the digital broadcasting system according to the present invention there are defined invisible active areas corresponding to the selected locking points in a single picture 35. These invisible active areas can be defined for each frame in a digital video program according to the present invention.

The active areas can be defined e.g. by a maximum distance from the locking point thus forming a circle shaped active areas. The active area can also have any other shape e.g. a rectangle or an ellipse. When there are several active areas within close vicinity from each other, the active areas can be defined smaller in size. As the movements of the locking points are tracked, also the positions of the invisible active areas are following the corresponding locking points.

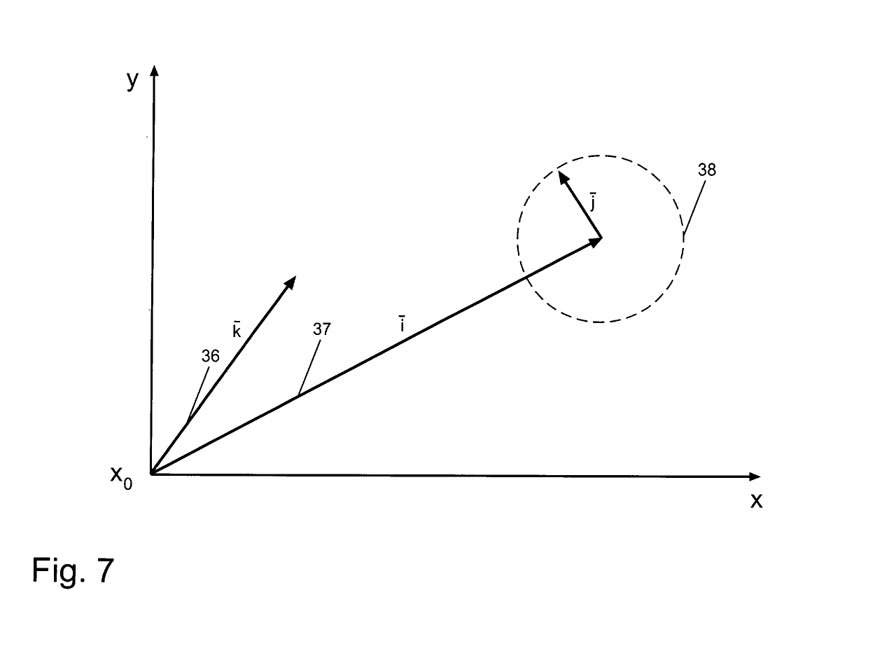

FIG. 7 illustrates the selecting of locking points and the defining of active areas with the help of vectors in a digital video program according to the present invention. In the digital broadcasting system according to the present invention there is a locking point defined with the help of length and angle of a vector \overline{i} 37. There is an active area defined with of a vector \overline{j} forming a circle shaped active area 38. In the figure there is also shown a vector \overline{k} 36 defining the position of a cursor of a user monitoring unit. When the vector \overline{k} 36 is not inside the active area 38 defined by the vector \overline{j}, the corresponding data application will not be activated.

In the digital broadcasting system according to the present invention the movements of the selected locking points in a digital video program are constantly tracked. In each frame of the digital video program there is location information relating to the selected locking points i.e. length and angle of a vector \overline{i} 37.

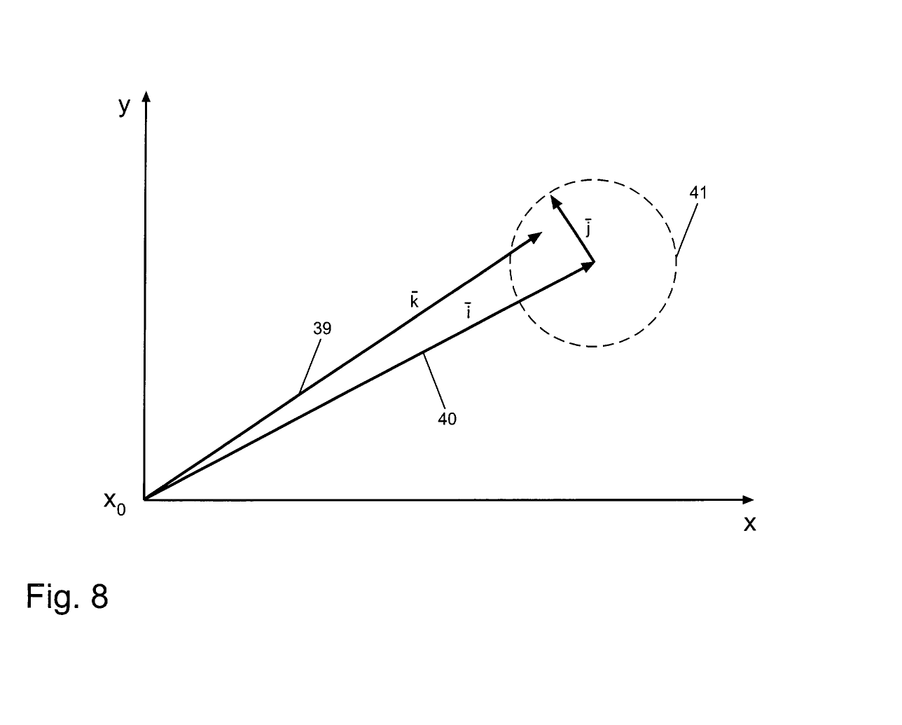

FIG. 8 illustrates the defining of active areas and the cursor movement with the help of vectors in a digital video program according to the present invention. In the digital broadcasting system according to the present invention there is a locking point defined with the help of length and angle of a vector \overline{i} 40. There is an active area defined with of a vector \overline{j} forming a circle shaped active area 41. In the figure there is also shown a vector \overline{k} 39 defining the position of a cursor of a user monitoring unit. When the vector \overline{k} 39 moves inside the active area 41 defined by the vector \overline{j} the corresponding data application will be activated.

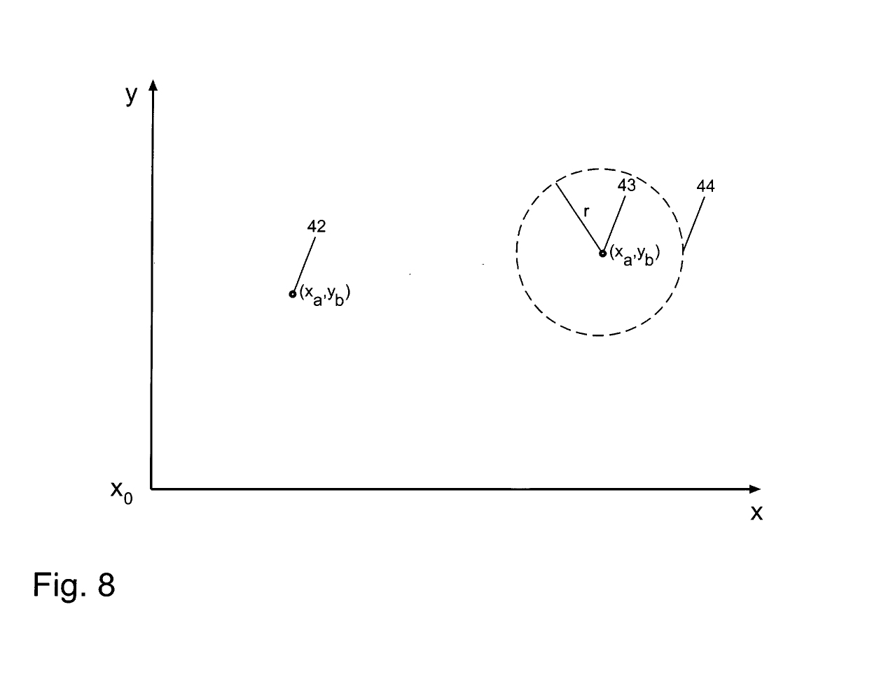

FIG. 9 illustrates the selecting of locking points and the defining of active areas with the help of coordinates in a digital video program according to the present invention. In the digital broadcasting system according to the present invention there is a locking point defined with the help of coordinates (xₐ,yₐ) 43. There is an active area defined with radius r forming a circle shaped active area 44. In the figure there is also shown coordinates (xₖ,yₖ) 42 defining the position of a cursor of a user monitoring unit. When the coordinates (Xₖ,yₖ) 42 are not inside the active area 44 defined by the radius r, the corresponding data application will not be activated.

In the digital broadcasting system according to the present invention the movements of the selected locking points in a digital video program are constantly tracked. In each frame of the digital video program there is location information relating to the selected locking points i.e. coordinates (xₐ,yₐ) 43.

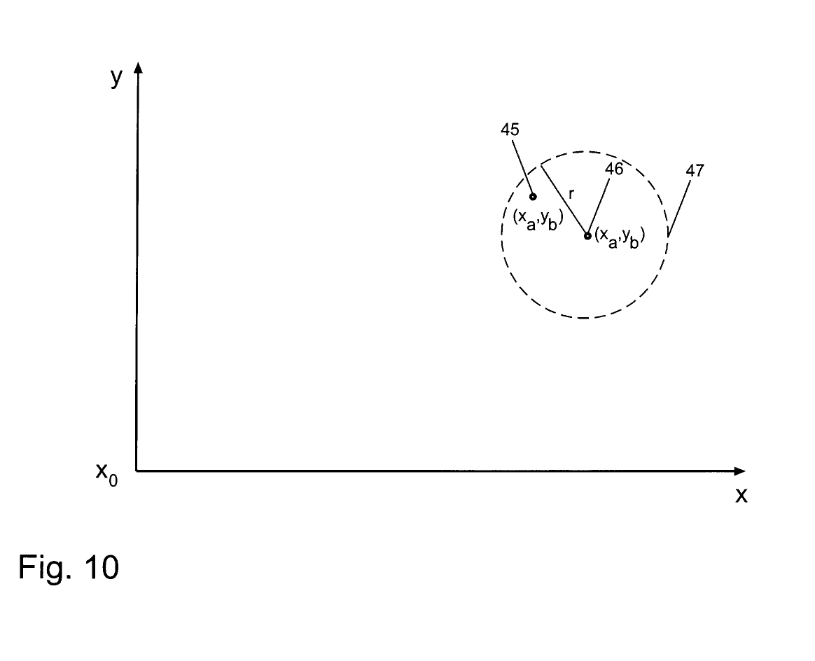

FIG. 10 illustrates the defining of active areas and the cursor movement with the help of coordinates in a digital video program according to the present invention. In the digital broadcasting system according to the present invention there is a locking point defined with the help of coordinates (xₐ,yₐ) 46. There is an active area defined with radius r forming a circle shaped active area 47. In the figure there is also shown coordinates (xₖ,yₖ) 45 defining the position of a cursor of a user monitoring unit. When the coordinates (xₖ,yₖ) 45 move inside the active area 47 defined by the radius r, the corresponding data application will be activated.

The active area corresponding to a specific locking point can be defined as a function or a group of functions relating to the locking point. Also the active area can be set to be updated for every frame. Alternatively, the active area can be set to remain same for X frames and to be updated for every X^{th} frame, where X is an integer.

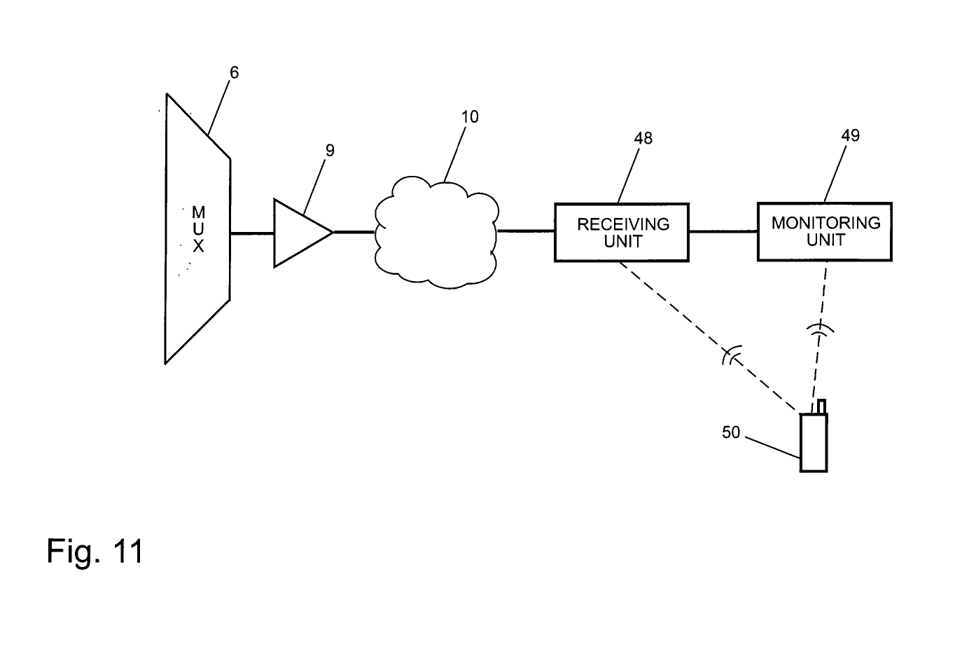

FIG. 11 illustrates a receiving system for receiving a video stream combined with data according to the present invention. The receiving system according to the present invention comprises a receiving unit 48, a monitoring unit 49 and a user control device 50. The presented receiving system receives the video stream from a digital broadcasting system. The digital broadcasting system has a multiplexer 6, in which all the different video program streams and digital data streams are multiplexed into a multi-program transport stream. From the multiplexer 6 the broadcasting stream is forwarded to a transmitter unit 9.

The transmitter unit 9 sends the stream over a transport network 10 to the receiving unit 48 of the receiving system. The receiving unit 48 demultiplexes the incoming multi-program stream and forwards the currently monitored program stream to the monitoring unit 49 of the receiving system. The monitoring unit 49 monitors the currently monitored program to the user. User can control the receiving unit 48 and the monitoring unit 49 with a user control device 50. The receiving unit 48 and the monitoring unit 49 can be combined as one unit. Also the receiving unit 48, the monitoring unit 49 and the user control device 50 can all be combined as one unit.

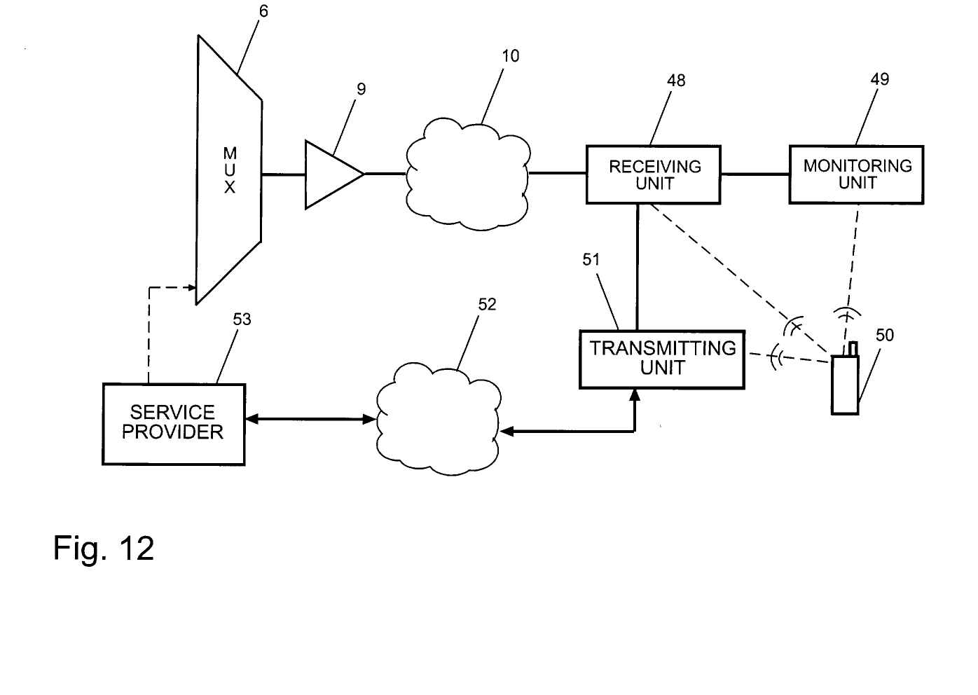

FIG. 12 illustrates another embodiment of a receiving system for receiving a video stream combined with data according to the present invention. The receiving system according to the present invention comprises a receiving unit 48, a monitoring unit 49 and a user control device 50 and a transmitting unit 51. The presented receiving system receives the video stream from a multiplexer 6 of a digital broadcasting system. From the multiplexer 6 the broadcasting stream is forwarded to a transmitter unit 9.

The transmitter unit 9 sends the stream over a transport network 10 to the receiving unit 48 of the receiving system. The receiving unit 48 demultiplexes the incoming multi-program stream and forwards the currently monitored program stream to the monitoring unit 49 of the receiving system. The monitoring unit 49 monitors the currently monitored program to the user.

In the receiving system according to the present invention the incoming multi-program stream also includes an application, which is then further used to constantly track the movements of the selected locking points in a digital video program.

In the receiving system according to the present invention there is also a transmitting unit 51, which can be used to transmit information from the user to a service provider 53 over a transport network 52. User can control the receiving unit 48, the monitoring unit 49 and the transmitting unit 51 with a user control device 50.

In the receiving system according to the present invention the transmitting unit 51 can send a business transaction request from the user to a service provider 53 e.g. for a purchase of a product or a service. The transmitting unit 51 can also be equipped to receive a confirmation from the service provider 53 to the user. The receiving unit 48, the monitoring unit 49 and the transmitting unit 51 can be combined as one unit. Also the receiving unit 48, the monitoring unit 49, the user control device 50 and the transmitting unit 51 can all be combined as one unit.

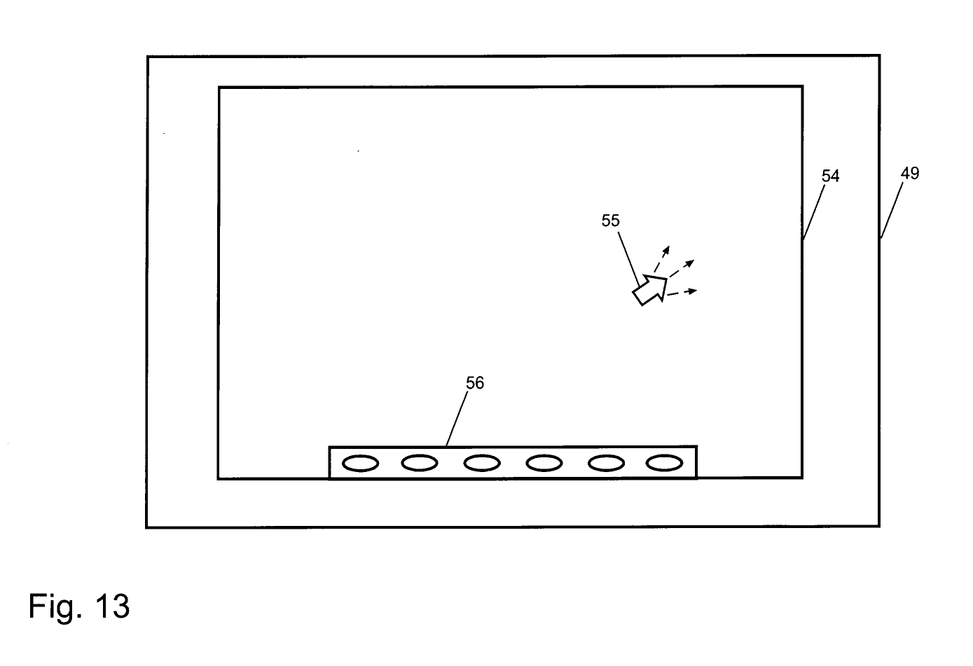

FIG. 13 illustrates a monitoring unit according to the present invention. The monitoring unit according to the present invention comprises a monitoring device 49 having a screen display 54. The screen display 54 has a movable cursor 55 and can also have a set of selecting buttons 56. The movement of the cursor 55 as well as the selection of the selecting buttons 56 can be controlled with the user control device 50.

In the receiving system according to the present invention the incoming multi-program stream also includes an application, which is then further used to constantly track the movements of the selected locking points in a digital video program. As the movements of the selected locking points are being tracked, also the location of the active areas relating to the locking points are constantly being compared with the movements of the cursor.

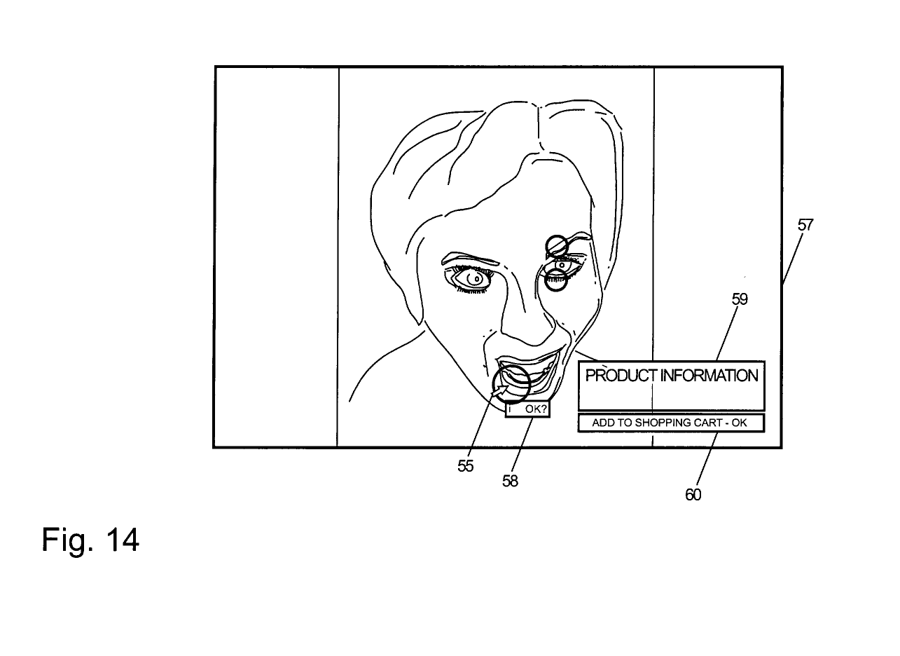

FIG. 14 illustrates the starting of a data application in a receiving system according to the present invention. The monitoring unit in the receiving system according to the present invention has a screen display 57 with a movable cursor 55. The user can control the movement of the cursor 55 with the user control device 50. When the user moves the cursor to be on a defined active area, the first data application will start automatically.

First the data application can show a confirmation prompt 58 to the user and ask the user to confirm, that the user is willing to proceed with the data application. The user can confirm willingness to proceed with the user control device 50. The data application can now start showing information 59 e.g. product information 59 in accordance to the selected active area. In the presented figure this product information 59 can present the different make-up products, the lady in the video program is using i.e. make-up powder, anti-wrinkle eye cream, eyelid colour, eye lining, mascara and lipstick.

The data application can also display selection buttons to the user. A selection button can for example be a button 60 confirming the purchase of a product. The data application can also be set to start directly without a confirmation from the user. Also the data application can be set to prompt further options that the user can activate with the user control device 50. The prompting of further options can e.g. be done with buttons, hyperlinks or highlighted active areas.

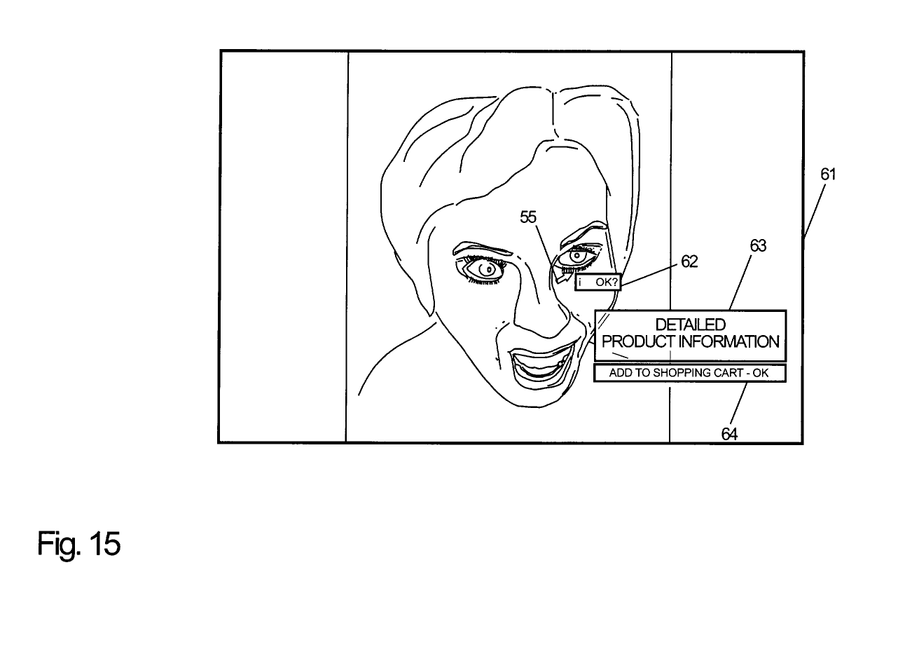

FIG. 15 illustrates the activating of further options of a data application in a receiving system according to the present invention. The monitoring unit in the receiving system according to the present invention has a screen display 61 with a movable cursor 55. The user can move the cursor 55 to a desired position and activate further options of a data application with the user control device 50.

The data application can show e.g. detailed product information 63 and a selection button 64 confirming the purchase of a product. In the presented figure this detailed product information 63 can present the detailed characteristics of an anti-wrinkle eye cream the lady in the video program is using.

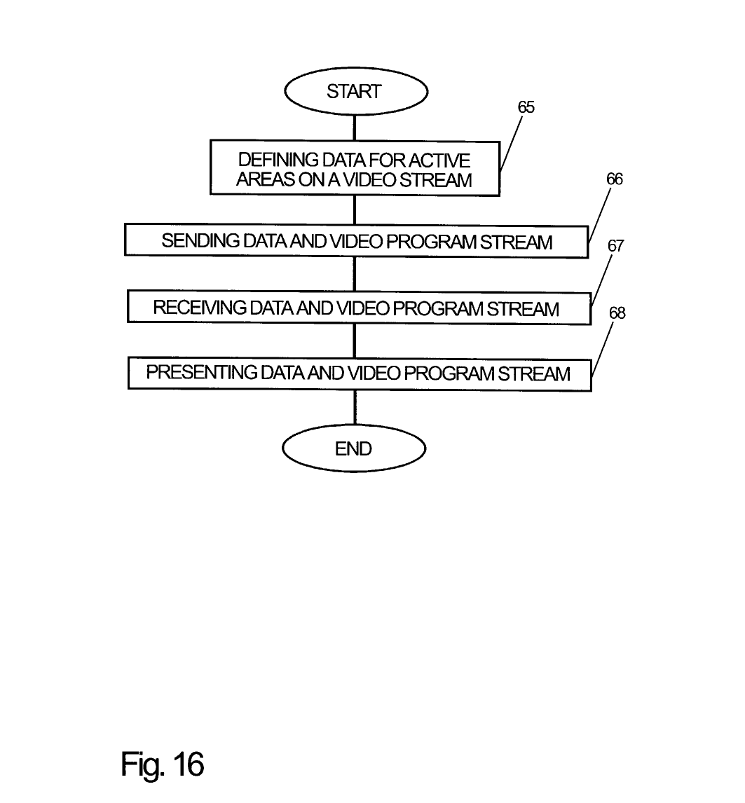

FIG. 16 illustrates a method for transmitting and receiving a combined video stream with data according to the present invention. First there is data defined 65 for the active areas on a video stream. The data and video program is then sent 66 over a transport network 10 to the receiving side. At the receiving side the data and video program is received 67. Thereafter the data and video program stream is presented 68 to the user.

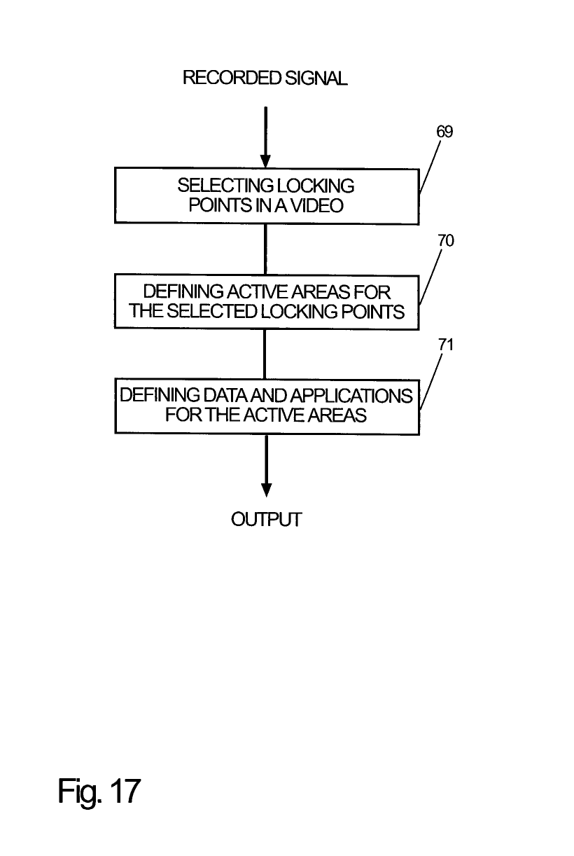

FIG. 17 illustrates a method for combining video stream with data according to the present invention. First there are locking points selected 69 in a single picture of a incoming digital video program in a video stream. Next the active areas are defined 70 for the selected locking points. Thereafter specific data and applications are defined 71 for the active areas. The output digital video program with the combined data and applications is ready to be sent out.

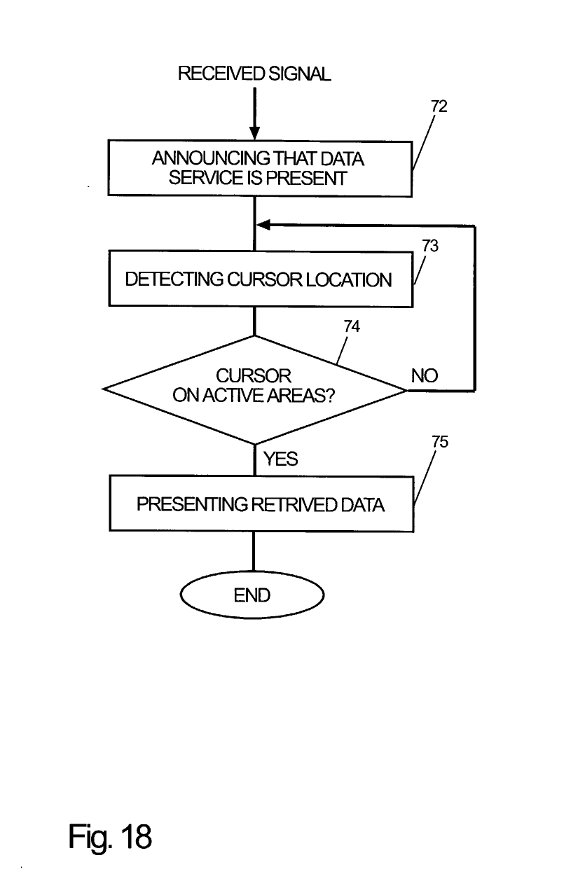

FIG. 18 illustrates a method for presenting a combined video stream with data according to the present invention. First there is announced 72 to the user that there is a data service present. This can be done in the recorded video program itself e.g. by announcing verbally or with help of a prompt e.g. text or a known figure added to the video program. As the service is active, the location of the cursor is constantly being detected 73. When it is detected 74 that the cursor is on the active areas, the retrieved data from the data application is presented 75.

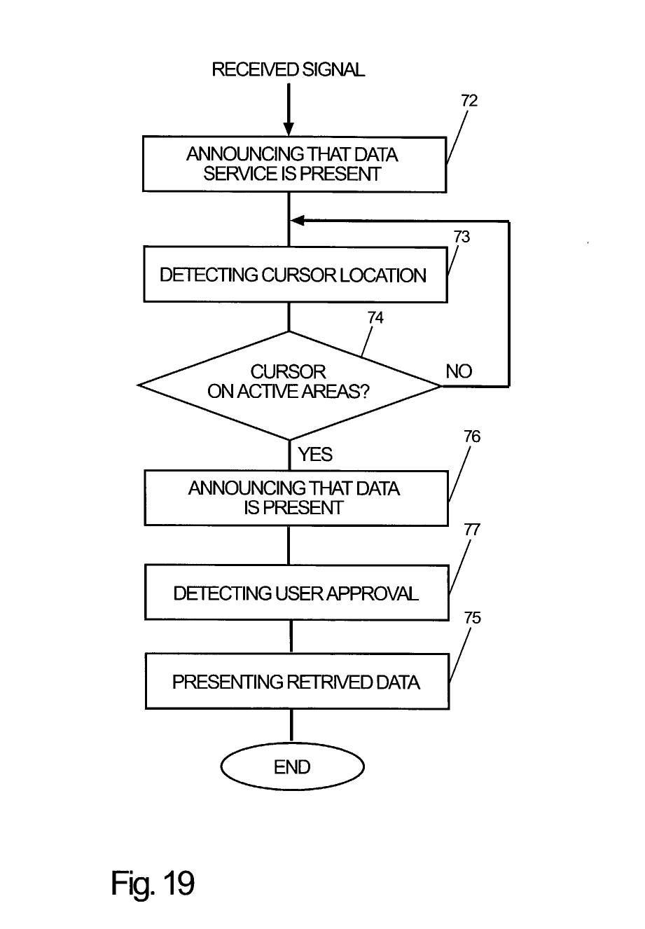

FIG. 19 illustrates a second alternative method for presenting a combined video stream with data according to the present invention. First there is announced 72 to the user that there is data service present. As the service is active, the location of the cursor is constantly being detected 73. When it is detected 74 that the cursor is on the active areas, there is announced 76 to the user that there is retrievable data present. When the retrievable data has been announced 76 to the user, there is user approval being detected 77. When the data service application has detected 77 user approval, the retrieved data from the data application is presented 75.

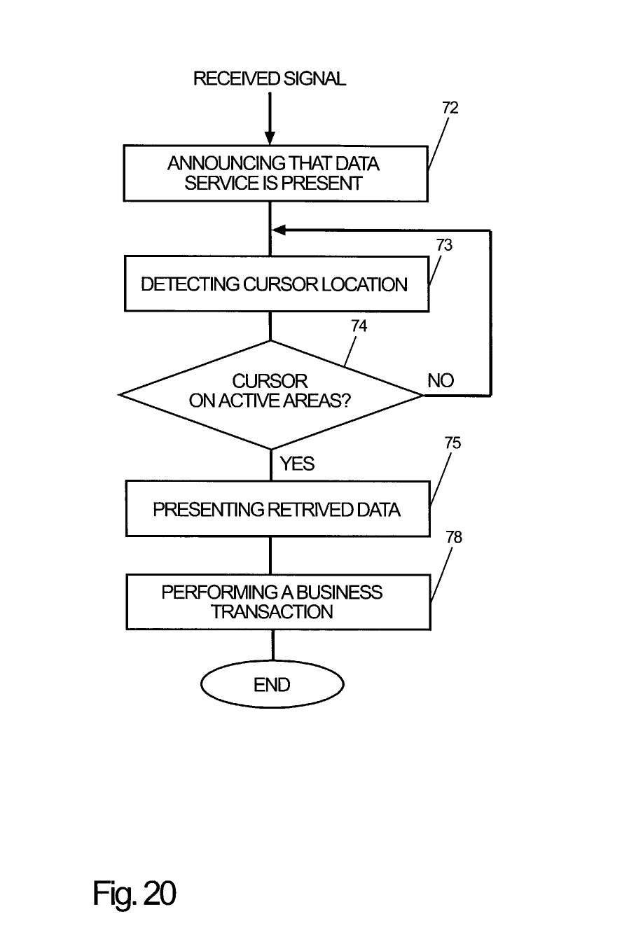

FIG. 20 illustrates a third alternative method for presenting a combined video stream with data according to the present invention. First there is announced 72 to the user that there is a data service present. As the service is active, the location of the cursor is constantly being detected 73. When it is detected 74 that the cursor is on the active areas, the retrieved data from the data application is presented 75. After the data has been presented 75 to the user, the user can perform 78 a business transaction. With the help of a transmitting unit 51 in the receiving system according to the present invention, the user can send a business transaction request from the user to a service provider 53 e.g. for a purchase of a product or a service. The transmitting unit 51 can also be equipped to receive a confirmation from the service provider 53 to the user.

The present invention provides a solution for combining video stream with digital information, which can be utilized in different future networks, such as digital television networks, third generation mobile networks and IP networks (IP, Internet Protocol).

1. A digital transmission system for transmitting and receiving digital information, said digital transmission system comprising:
processing means (15) for combining recorded signals from different audio and video sources to a single video program stream,
motion tracking means (16) for defining active areas in a selected video program stream,
linking means for linking appropriate application data to the corresponding active areas in the video program stream,
transmitting means for transmitting the video stream over a transport network (10) to the receiving side,
receiving means (48) for receiving the incoming video stream,
monitoring means (49) for presenting the monitored program to the user, and
controlling means (50) for controlling the receiving means (48) and the monitoring means (49).

2. A digital transmission system according to claim 1, wherein said transmitting means comprises
storing and forwarding means (19), and
multiplexing means (6) for multiplexing different digital video program streams and digital data streams into a multi-program transport stream, and
sending means (9), so that
the storing and forwarding means (19) receives application data from different applications (20), and forwards the appropriate application data to the multiplexing means (6).

3. A digital transmission system according to claim 1 or claim 2, wherein said motion tracking means (16) forwards the knowledge of the active areas to the said multiplexing means (6) via the storing and forwarding means (19).

4. A digital transmission system according to claim 1 or claim 2, wherein said motion tracking means (16) forwards the knowledge of the active areas to the said multiplexing means (6) via a system information table (8).

5. A digital transmission system according to claim 1 or claim 2, wherein said motion tracking means (16) forwards the knowledge of the active areas directly to the said multiplexing means (6).

6. A digital transmission system according to any of the claims 2-5, wherein said storing and forwarding means (19) has a Carousel unit (25) and a Database server (24) having a connection to one or more client units (21)-(23), so that
the Database server (24) receives information from the client units (21)-(23), stores the client information, and forwards the client information to the Carousel unit (25), and that
the Carousel unit (25) forwards the appropriate application data corresponding to the active areas to the multiplexing means (6).

7. A digital transmission system according to any of the claims 2-6, wherein said storing and forwarding means (19) has also an automation system (26), which controls both the Database server (24) and the Carousel unit (25).

8. A data combining arrangement for combining application data to a video program stream in a digital transmission system, said data combining arrangement comprising:
processing means (15) for combining recorded signals from different audio and video sources to a single video program stream,
motion tracking means (16) for defining active areas in a selected video program stream, and
linking means for linking appropriate application data to the corresponding active areas in the video program stream, and
transmitting means for transmitting the video stream over a transport network (10) to the receiving side.

9. A data combining arrangement according to claim 8, wherein said transmitting means comprises
storing and forwarding means (19), and
multiplexing means (6) for multiplexing different digital video program streams and digital data streams into a multi-program transport stream, and
sending means (9), so that
the storing and forwarding means (19) receives application data from different applications (20), and forwards the appropriate application data to the multiplexing means (6).

10. A data combining arrangement according to claim 8 or claim 9, wherein said motion tracking means (16) forwards the knowledge of the active areas to the said multiplexing means (6) via the storing and forwarding means (19).

11. A data combining arrangement according to claim 8 or claim 9, wherein said motion tracking means (16) forwards the knowledge of the active areas to the said multiplexing means (6) via a system information table (8).

12. A data combining arrangement according to claim 8 or claim 9, wherein said motion tracking means (16) forwards the knowledge of the active areas directly to the said multiplexing means (6).

13. A data combining arrangement according to any of the claims 9-12, wherein said storing and forwarding means (19) has a Carousel unit (25) and a Database server (24) having a connection to one or more client units (21)-(23), so that
the Database server (24) receives information from the client units (21)-(23), stores the client information, and forwards the client information to the Carousel unit (25), and that
the Carousel unit (25) forwards the appropriate application data corresponding to the active areas to the multiplexing means (6).

14. A data combining arrangement according to any of the claims 9-13, wherein said storing and forwarding means (19) has also an automation system (26), which controls both the Database server (24) and the Carousel unit (25).

15. A data combining arrangement according to any of the claims 9-14, wherein the active areas in a selected video program stream are defined by
selecting locking points,
defining the active areas around the locking points, and
tracking the movement of the locking points and the active areas in a selected video program stream using motion tracking means (16).

16. A data combining arrangement according to claim 15, wherein the movement of the locking points is calculated based on differences between frames following each other.

17. A data combining arrangement according to claim 15 or claim 16, wherein the locking points are defined with vectors.

18. A data combining arrangement according to claim 15 or claim 16, wherein the locking points are defined with coordinates.

19. A data combining arrangement according to any of the claims 15-18, wherein the active area corresponding to a specific locking point is defined as a function or a group of functions relating to the locking point.

20. A data combining arrangement according to any of the claims 15-19, wherein the active area is updated for every frame.

21. A data combining arrangement according to any of the claims 15-19, wherein the active area remains same for X frames and is updated for every X^{th} frame, where X is an integer.

22. A data combining arrangement according to any of the claims 15-21, wherein the size and the shape of the active areas depend on the distance between locking points located close to each other.

23. A data combining arrangement according to any of the claims 15-21, wherein the size and the shape of the active areas depend on the distance between active areas located close to each other.

24. A data presenting arrangement for presenting a video program stream combined with application data in a digital transmission system, said data presenting arrangement comprising:
receiving means (48) for receiving the incoming video stream from a digital broadcasting system, in which the application data is linked to the relating video program stream, and all the different video program streams are multiplexed into a multi-program transport stream,
monitoring means (49) for presenting the monitored program to the user, and
controlling means (50) for controlling the receiving means (48) and the monitoring means (49).

25. A data presenting arrangement according to claim 24, wherein the receiving unit (48) and the monitoring unit (49) are combined as one unit.

26. A data presenting arrangement according to claim 24, wherein the receiving unit (48), the monitoring unit (49) and the user control device (50) are combined as one unit.

27. A data presenting arrangement according to claim 24, said data presenting arrangement also comprises:
transmitting means (51) for transmitting information from the user to a service provider (53) over a transport network (52).

28. A data presenting arrangement according to claim 27, wherein the said controlling means (50) is also used for controlling the transmitting unit (51).

29. A data presenting arrangement according to claim 27 or claim 27, wherein the transmitting unit (51) is equipped for sending a business transaction request from the user to a service provider (53).

30. A data presenting arrangement according to any of the claims 27-29, wherein the transmitting unit (51) is equipped for receiving a confirmation from the service provider (53) to the user.

31. A data presenting arrangement according to any of the claims 27-30, wherein the receiving unit (48), the monitoring unit (49) and the transmitting unit (51) are combined as one unit.

32. A data presenting arrangement according to any of the claims 27-30, wherein the receiving unit (48), the monitoring unit (49), the user control device (50) and the transmitting unit (51) are combined as one unit.

33. A data presenting arrangement according to any of the claims 24-32, wherein the said monitoring device (49) has a screen display (54), (57) with a movable cursor (55), and means for cursor location detection.

34. A data presenting arrangement according to claim 33, wherein incoming multi-program stream also includes an application, which is used to produce a movable cursor (55) for the monitoring device (49).

35. A data presenting arrangement according to claim 33 or claim 34, wherein the said movable cursor (55) can be controlled with the user control device (50).

36. A data presenting arrangement according to any of the claims 33-35, wherein the incoming multi-program stream also includes an application, which is used for constantly tracking the movements of the selected locking points in a digital video program, and constantly comparing the location of the active areas relating to the locking points with the movements of the cursor.

37. A data presenting arrangement according to claim 36, wherein the said screen display (54), (57) has a set of selecting buttons (56), which selecting buttons (56) can be controlled with the user control device (50).

38. A data presenting arrangement according to claim 36 or claim 37, wherein when the cursor is moved to be on a defined active area, the first data application will start automatically.

39. A data presenting arrangement according to any of the claims 36-38, wherein the data application first shows a confirmation prompt (58) to the user and asks the user to confirm with the user control device (50), that the user is willing to proceed with the data application.

40. A data presenting arrangement according to any of the claims 36-39, wherein the data application shows information (59) relating to the selected active area.

41. A data presenting arrangement according to claim 40, wherein the data application displays selection buttons to the user.

42. A data presenting arrangement according to claim 41, wherein the data application shows a selection button (60), (64) confirming a purchase of a product.

43. A method for transmitting and receiving a combined video stream with data, said method comprising the steps of:
defining (65) data for active areas on a video stream,
sending (66) data and video program over a transport network (10) to the receiving side,
receiving (67) data and video program at the receiving side, and
presenting (68) data and video program stream to the user.

44. A method for combining video stream with data, said method comprising the steps of:
selecting (69) locking points in a single picture of a incoming digital video program in a video stream,
defining (70) active areas for the selected locking points, and
defining (71) data and applications for the active areas.

45. A method for presenting a combined video stream with data, said method comprising the steps of:
announcing (72) to the user that there is a data service present,
detecting (73) the location of the cursor, and comparing the location of the cursor to the location of the active areas detected by an application received in the multi-program transport stream, and
when it is detected (74) that the cursor is on the active areas, presenting (75) the retrieved data from the data application.

46. A presenting method according to claim 45, wherein when it is detected (74) that the cursor is on the active areas,
it is announced (72) to the user that there is data service present,
user approval is detected (77), and
the retrieved data from the data application is presented (75).

47. A method for performing a business transaction in a digital transmission system, said method comprising the steps of:
announcing (72) to the user that there is a data service present,
detecting (73) the location of the cursor,
when it is detected (74) that the cursor is on the active areas, presenting (75) the retrieved data from the data application, and
the user performing (78) a business transaction.
